(19) United States
(12) Patent Application Publication
(10) Pub. No.: US 2008/0141372 A1
(43) Pub. Date: Jun. 12, 2008

(54) Electronic Data Integrity Checking and Validation

(75) Inventors: David Todd Massey, Fort Collins, CO (US); William Paul Thorson, Fort Collins, CO (US)

Correspondence Address: HENSLEY KIM & HOLZER, LLC, 1660 LINCOLN STREET, SUITE 3000, DENVER, CO, 80264, US

(73) Assignee: PRIVACY NETWORKS, INC., Fort Collins, CO (US)

(21) Appl. No.: 11/609,791

(22) Filed: Dec. 12, 2006

(51) Int. Cl. G06F 21/00

(52) U.S. Cl. 726/23

(57) ABSTRACT

An integrated electronic data communications system enforces a data integrity policy to validate the electronic data (e.g., determine whether the electronic data is a corporate asset or an unwanted threat). Upon validation, data is archived in real time in a searchable repository, encrypted/decrypted automatically, and forwarded to a mobile device, if appropriate. Example electronic data that may be communicated through such a system may include without limitation email, VOIP data, FTP data, Web traffic, data communicated through a corporation's Virtual Private Network (VPN), etc.

### BACKGROUND

Electronic data communications, such as email, File Transfer Protocol (FTP) communications, Voice-Over-IP (VOIP) communications, instant messaging, Web communications, etc., can be considered a form of corporate asset. When a user deletes the content of the electronic data communication (e.g., deletes an email document), the asset can be lost. Even with some type of periodic (e.g., nightly) backup system, many electronic data communication documents are often deleted prior to the actual backup operation, so the asset is still lost. Furthermore, when attempting to restore a lost or corrupted document from a traditional backup system, the company is typically required to manually search through multiple old backup tapes, which are limited to a defined snapshot time period, in an attempt to locate the document. As such, there are no convenient automated solutions for performing keyword searches across such archives.

Moreover, much of what is backed up to the periodic archives of traditional approaches may be tainted data. For example, both email servers and email clients can provide some form of spam or virus protection. However, typically, the spam or infected documents are still stored on the server or email client and therefore archived on a periodic basis. As a result, tainted data is stored in combination with a company's valuable electronic data assets, which wastes storage space and risks further infection of the legitimate corporate assets.

Similarly, basic electronic communications are not secure when transmitted over a computer network, such as the Internet. Encryption/decryption technologies exist to allow a user to encrypt data at their client. However, the inconvenience of executing the encryption/decryption application for each email, managing various private and public keys needed to encrypt and decrypt the data, etc. limits the actual use of such technologies. Furthermore, the private and public keys in previous approaches are typically owned or controlled by the individual, rather than the enterprise. As such, as data is backed up, the enterprise may not have access to the keys and therefore may not be able to search or decrypt encrypted documents recorded on the backup tape.

Moreover, the introduction of mobile clients (e.g., laptops, PDA's and other mobile communication devices) introduces another level of complexity in managing electronic communications. For example, a Blackberry device introduces a new source of security risk, infection, and archival needs.

In addition, the point solutions discussed (e.g., periodic tape backups, spam filters and antivirus solutions, and encryption/decryption technologies) are not integrated under a corporation's security policy. Instead, a corporation may schedule and execute backups, which are independent of a user's spam filtering and encryption/decryption practices. Therefore, a lack of integration under a corporate security policy therefore introduces security gaps, storage inefficiencies, and user inconvenience.

### SUMMARY

Implementations described and claimed herein address the foregoing problems by providing an integrated system and method for handling electronic data communications. With the system, a data integrity policy is enforced to validate the electronic data (e.g., determine whether the electronic data is a corporate asset or an unwanted threat). Upon validation, data may be archived in real time in a searchable repository, encrypted/decrypted automatically (as needed), and forwarded to a mobile device, if appropriate. Example electronic data that may be communicated through such a system may include without limitation email, VOIP data, instant messaging, FTP data, Web traffic, data communicated through a corporation's Virtual Private Network (VPN), etc.

In some implementations, articles of manufacture are provided as computer program products. One implementation of a computer program product provides a tangible computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example data integrity system within a data communications architecture.

FIG. 2 illustrates components of an example data integrity system within a data communications architecture.

FIG. 3 illustrates example operations for processing inbound communications.

FIG. 4 illustrates example operations for processing outbound communications.

FIG. 5 illustrates an example system that may be useful in implementing the described technology.

FIG. 6 illustrates an example screenshot for retrieving archived messages of a selected user.

FIG. 7 illustrates an example screenshot for searching archived messages.

### DETAILED DESCRIPTIONS

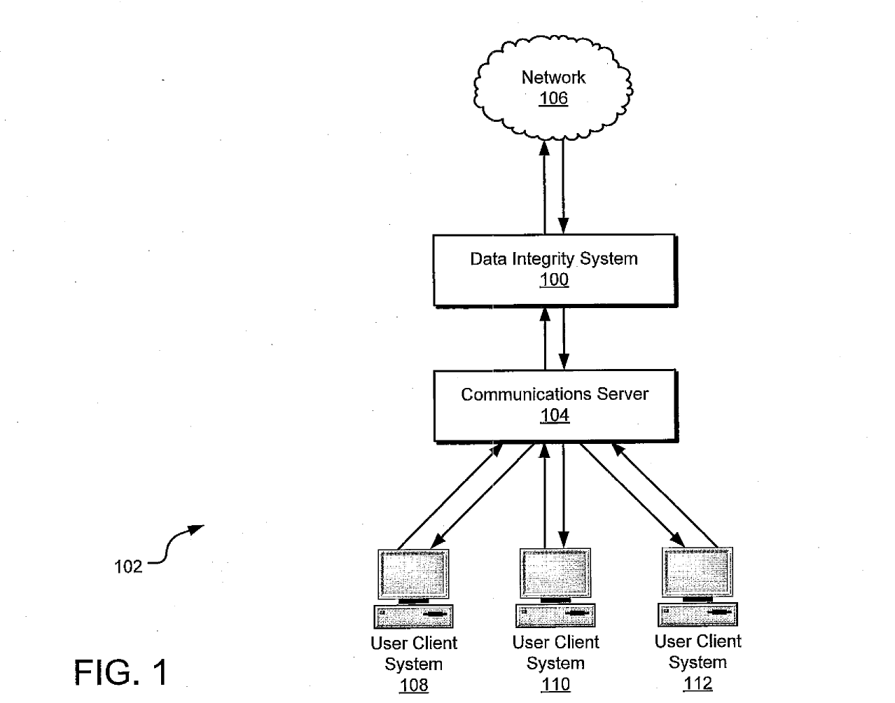

FIG. 1 illustrates an example data integrity system 100 within a data communications architecture 102. The illustrated data integrity system 100 is connected between a communications server 104 (such as an email server) and the communications network 106 (such as but not limited to an intranet or the Internet). In one implementation, the data integrity system 100 includes one or more Web interfaces to manage Web-based communications, although other network interfaces may also be employed, including a TCP/IP interface, a VPN interface, an FTP interface, a VOIP interface, a mobile phone interface, an application programming interface (API), etc. Multiple user client systems 108, 110, and 112 (i.e., “clients”) are connected to the communications server 104 (e.g., via another communications network). In this manner, the clients 108, 110, and 112 can send and receive data communications through the communications server 104 and the data integrity system 100 to and from the communication network 106.

Data communicated to and from the communications network 106 can take many forms, each form having a specified format. For example, typical email messages consist of multiple components and comply with RFC 2822 or MIME (RFC 2045), although other email formats are contemplated. MIME (Multipurpose Internet Mail Extensions) is an Internet standard that extends the format of email data to support text in character sets other than US-ASCII, non-text attachments, multi-part message bodies, and header information in non-ASCII character sets. In contrast, other forms of communication, such as FTP and VOIP communications comply with other format standards.

Generally, email formats specify an envelope, one or more headers, and a message body, which may include one or more attachments. The envelope is used by Message Transfer Agents (MTAs) to route the message over the communications network 106. The headers may include various mandatory and optional information, such as the transmission date, one or more destinations (e.g., To:, CC:, and BCC: addresses), the source (e.g., a From: address), a message identifier from the originating system, a return path, custom header fields, MIME version fields, and a subject. Typically, the message body includes the actual content of the message, and any binary data included in the message body is encoded into ASCII text.

One or more components of an email message (or any other communications data) may be encrypted or infected by some type of malware. Accordingly, example operations of a data integrity system for inbound communications may include decryption and validation of message components. Likewise, example operations of a data integrity system for outbound communications may include encryption and validation. Furthermore, both corporate and user-centric security policies may include real-time archiving and forwarding to a one or more mobile clients.

A management module (not shown) within the data integrity system 100 allows an administrator or user to access archived communications and set data integrity policies and preferences. In one implementation, the management module is accessible via the data integrity system's Web interface. A user's security identifier allows him or her to access specific areas of the system for retrieving, searching, and viewing communications and data that are stored within (or are accessible by) the system, such as in a quarantine or in an archive. For example, searches can be based on or limited by one's security identifier.

In addition, an enterprise may set policies for encryption, validation, archival, and mobility based on users' security identifiers, and a user can set user-level policies for the same functionality based on his or her security identifier. The management module can also rely on a user's security identifier to determine which policies the user may edit through a Web interface and what messages the user may access within the system. Example policies that may be set based on security identifiers may include without limitation:
Whether to enable message blocking and for what types of data (e.g., based on file suffix or data packet type)
Whether and how to notify the user about a blocked message
The maximum time to hold a message in quarantine, a graybox, or a trashcan
The maximum number of messages to hold a message in quarantine, a graybox, or a trashcan
Whitelists and blacklists
Objectionable word lists
Alternative email addresses for Antivirus Update Emails, redirection, and mobility forwarding
Security policies, including passwords, public and private keys, and access lists
Validation policies, including validation rules and malware signatures
Mobility policies, including destination addresses, forwarding times and forwarding filters

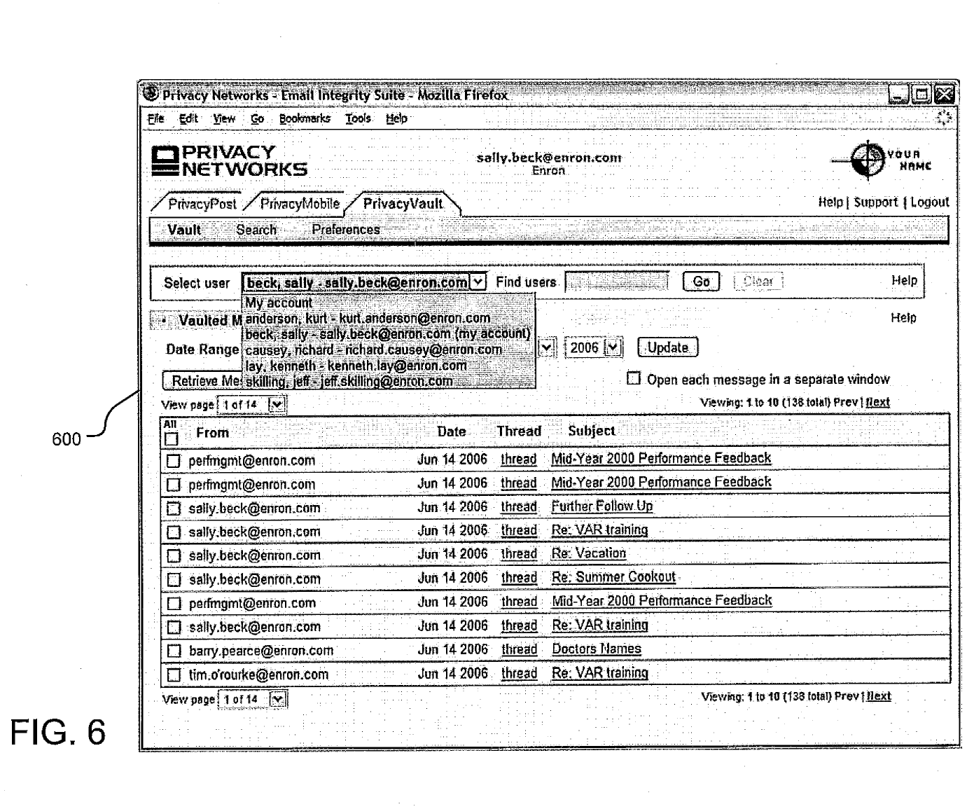

As an example, FIG. 6 illustrates an example screenshot for retrieving archived messages of a selected user. The current user (i.e., Sally Beck) is associated with an access list, which defines the users whose messages the current user has access to. As shown, Sally Beck has access to the messages of Kurt Anderson, Richard Causey, Kenneth Lay, and Jeff Skilling because these individuals are listed in Sally Beck's access list. Access lists can be modified by other users (e.g., a user can grant Sally Beck access to the user's messages) or by an administrator (e.g., the administrator can grant Sally Beck's assistant access to Sally Beck's emails).

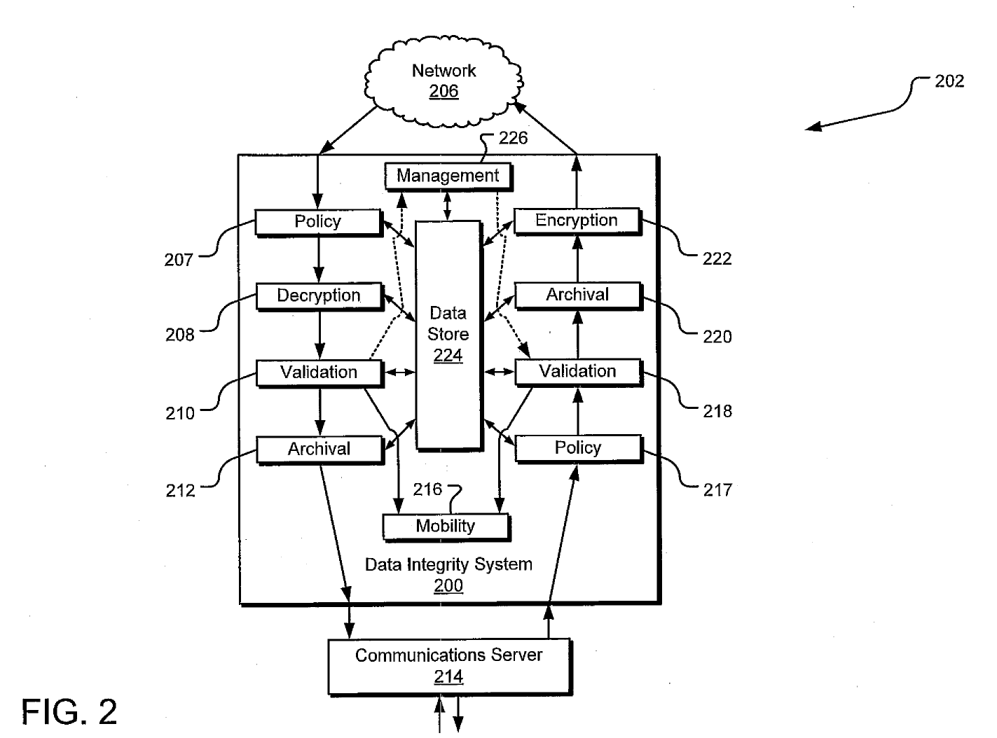

FIG. 2 illustrates components of an example data integrity system 200 within a data communications architecture 202. On one side, which may be internal to the subnetwork, the data integrity system 200 sends and receives data communications to and from a communications server 204 (e.g., an email server), which can communicate with one or more clients. On the other side, the data integrity system 200 sends and receives data communications externally to and from a communications network 206 (such as but not limited to an intranet or the Internet).

Within the data integrity system 200, inbound communications (i.e., from the communications network 206) flow through a sequence of inbound message processing modules: a policy module 207, a decryption module 208, a validation module 210, and an archival module 212. The inbound message is then forwarded to the communications server 214 for typical communications processing (e.g., storage in the appropriate user's inbox, access by the user, etc.). In addition, the inbound message may also be forwarded to a mobile communications device (e.g., a user's Smartphone) or other remote system via a mobility module 216.

Likewise, outbound communications (i.e., from the communications server 214) flow from through another sequence of output message processing modules: a policy module 217, a validation module 218, an archival module 220, and an encryption module 222. The outbound message is then forwarded to the communications network 206 for transmission to one or more destinations. In addition, the outbound message may also be forwarded to a mobile communications device (e.g., a user's Smartphone) or other remote system via a mobility module 216.

The manner in which individual modules of the inbound or outbound flows handle an individual message is based on an organizational data integrity policy. In one implementation, the organizational data integrity policy is stored in a policy cache of a data store 224, although the data store 224 may alternatively represent distributed storage within or accessible by the data integrity system 200. The organizational data integrity policy is generally set by a corporate information systems group, although individual users may input certain settings as well. For example, the organizational data integrity policy may require that all inbound and outbound data be validated before exiting the data integrity system 200. Alternatively, a user may be able to specify a forwarding address for email messages satisfying a specified criterion. Despite such user-controlled systems, the corporate information system group may set limitations to user control and/or may prevent or override certain user settings.

A management module 226 can receive validated communications from the Web or from within the subnetwork (see the dotted lines between the validation modules 210 and 218) to set security policies, set preferences, access archived data, etc. For example, a private key received in association with an internal user's email address may be sent through the management module 226 for storage in one or more security policies in the data store 224. In this manner, for example, when an encrypted message is received from a sender, the decryption module 208 can automatically look up the private key associated with the destination email address and decrypt the message in real time. With this approach, decryption is convenient in that it does not require the recipient to manually look up the private key and decrypt the message. Furthermore, the decrypted message can now be validated by the validation module 210, archived by the archival module 212, forwarded by the mobility module 216, and set to the communication server 214.

Having access to the private keys also allows the management module 226 to specify that certain received messages that are encrypted are to be decrypted by the decryption module 208. As such, the archival modules 212 can then index encrypted messages to allow for searching within the content of the encrypted messages, and the validation modules 210 and 218 can then validate encrypted messages to determine whether the electronic data is a corporate asset or an unwanted threat.

In one implementation, each message that enters the data integrity system 200, whether inbound or outbound) is received by a policy module, such as policy modules 207 and 217. Each policy module examines the message to associate a security identifier with the message. For example, a source address and/or destination address may be used as parameters to look up a security identifier from a security identifier table stored in data store 224. Other possible look up parameters may include roles, groups, access list entries, times, dates, communication types, etc. These parameters may be used individually or in combination to determine an appropriate security identifier for the communication.

Given a security identifier, the policy module determines a specific data integrity policy to be applied to the communication. In one implementation, the policy module looks up a data integrity policy from a data integrity policy table stored in the data store 224. It should also be understood that the security identifier and data integrity policy tables could be combined in an alternative implementation. Likewise, other implementations may look up an appropriate data integrity policy based only on the look up parameters, skipping the security identifier.

A data integrity policy sets out at least one of the validation, encryption, archival, and mobility policies for a communication. In most cases, the corporate information systems personnel manage these policies, but in some cases, users may be allowed to set certain data integrity policies (e.g., whether they want a mobility module to forward emails to their Smartphone). Data integrity policies and their component policies are described in more detail below with regard to individual data integrity modules.

In one implementation, the data integrity policy defines a decryption policy, which may include or reference private keys of internal message recipients. Therefore, having identified a decryption policy, the data integrity system 200 can decrypt an inbound message that has been encrypted with the recipient's public key. The decryption module 208 can automatically look up a private key associated with the destination address and decrypt the message before the messages is passed to subsequent modules in the inbound flow.

The validation module 210 validates inbound messages, determining whether the message is a potential corporate asset, a suspected spam message, a known spam message or an infected message. Various malware detection techniques may be employed for this purpose including signature-based and behavior-based malware detection. If an infected message is detected in the inbound flow, the validation module 210 marks the message as infected and sends the message to the quarantine in the data store 224. The quarantine allows the infected messaged to be acknowledged (e.g., announced to the user and/or an administrator) and stored but prevents viewing of the infected message as a protective measure.

If a known spam message is detected in the inbound flow, the validation module 210 sends the message to a detected spam section of quarantine in the data store 224. If a suspected spam message is detected in the inbound flow, the validation module 210 sends the message to a suspected spam section of quarantine in the data store 224. A message is considered detected or known spam if the source of the message is from a known spammer. A message is considered suspected spam if the source of the message is not known to be a spammer but the message was nevertheless identified as suspected spam by the validation module 210 (and validation module 218, for that matter). For example, the validation modules may identify a message as suspected spam because of the text included in the message (e.g., Rolex, mortgage, etc.) or some other evidence of spam. The validation modules can also receive validation rule updates that are emailed or downloaded to the user based on the validation policies and the user's security identifier.

The user can be notified of such detected or suspected spam messages so that the user or administrator can access the quarantine via the management module 226, determine whether the message is actually legitimate, and release specific messages from quarantine. Released messages are forwarded to the archival module 212 for reintroduction into the inbound flow. Validated messages are passed on to the archival module 212 without diversion to quarantine. Quarantined messages may be purged from the data store 224 after certain periods of time, as specified in the user and enterprise policies in the data integrity system 200.

Management requests from the web can also be communicated through these modules. For example, a user or administrator can access the management module 226 via the Web. Inbound management requests may be decrypted and validated by the modules 208 and 210. The management requests are sent from the validation module 210 to the management module 226. In alternative implementations, inbound management requests may also be archived by the archival module 212, which then forwards the management requests to the management module 226.

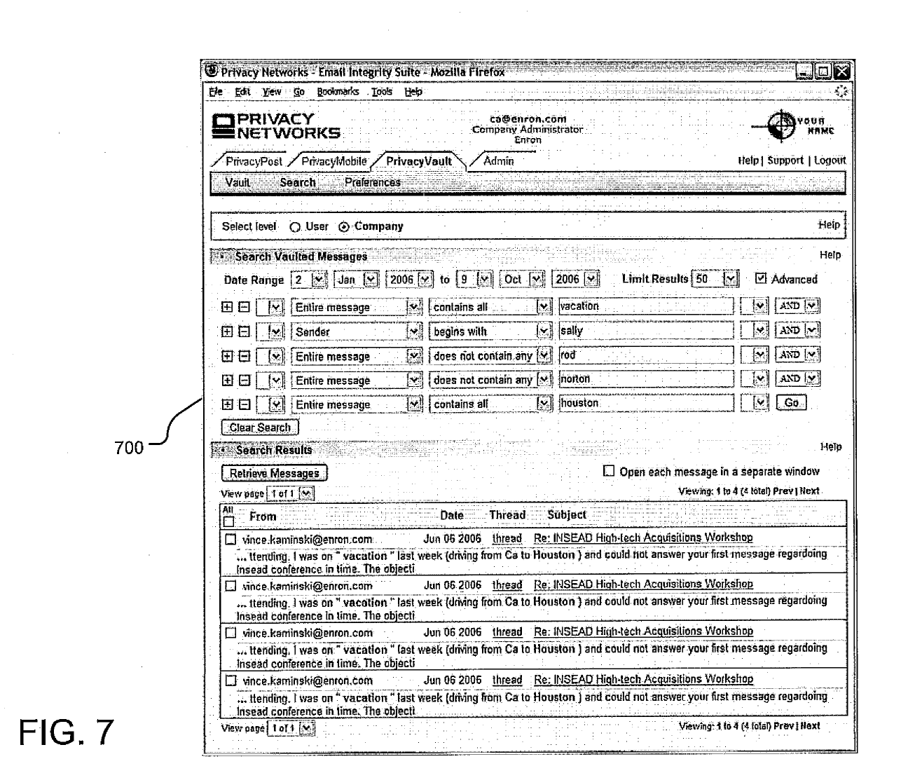

The archival module 212 indexes each validated inbound message and records it in a searchable archive in the data store 224. In this manner, invalid inbound messages do not occupy valuable storage space in the archive. Moreover, by indexing the message, the archive is keyword-searchable across all dates, allowing a user or administrator to search the archive through the management interface and retrieve previously deleted, corrupted, or lost messages. FIG. 7 illustrates an example screenshot for searching archived messages via a search module (not shown) within the data integrity system. The illustrated search fields are intended to be exemplary and not exhaustive. As depicted, a user has very flexible searching capabilities for searching through the user's archived messages. Furthermore, a user may be able to search archived messages of other users, subject to access list constraints. Because of the system's automated access to private keys, encrypted messages may also be searched by the searching module.

In addition to inbound messages being sent to the archival module 212 before being passed on to the communications server, they may also be copied and forwarded to a mobility module 216, which forwards the validated message on to a mobile communications device or other remote system. The mobility module 216 can forward the validated message based on the mobility policies set by the user or the enterprise.

In summary, the inbound flow allows a data integrity policy to be selected and applied by a policy module 207 for a given inbound message based on parameters of the message and, in at least one implementation, a security identifier. If the message is encrypted, the inbound message can decrypted by the decryption module 208 using a private key determined by virtue of the selected data integrity policy. A validation module 210 attempts to validate the inbound message (which is no longer encrypted). Invalidated messages are passed to quarantine and validated messages are passed along in the inbound flow. An archival module 212 indexes the inbound message and passed a copy of the message into an archive of the data store 224. Depending on the data integrity policy, the validation module 210 (or the archival module) may forward a copy of the message to the mobility module 216. After traversing the inbound flow modules of the data integrity system 200, the inbound message is passed to the communications server 214.

As for the outbound flow, an outbound message is received by the data integrity system 200 from the communications server 214. As discussed, a data integrity policy is selected by a policy module 217.

The validation module 218 validates outbound messages, determining whether the message is a legitimate communication, a suspected spam message, a known spam message or an infected message. Various malware detection techniques may be employed for this purpose including signature-based and behavior-based malware detection. If an infected message is detected in the outbound flow, the validation module 218 sends the message to a malware section of quarantine in the data store 224. If a known spam message is detected in the outbound flow, the validation module 218 sends the message to a detected spam section of quarantine in the data store 224. If a suspected spam message is detected in the outbound flow, the validation module 218 sends the message to a suspected spam section of quarantine in the data store 224. The user can be notified of such messages so that the user or administrator can access the quarantine via the management module 226, determine whether the message is actually legitimate, and release specific messages from quarantine. Released messages are forwarded to the archival module 220 for reintroduction into the outbound flow. Validated messages are passed on to the archival module 220 without diversion to quarantine. Quarantined messages may be purged from the data store 224 after certain periods of time.

Management responses can also be communicated through these modules. For example, a user or administrator can access the management module 226 via the Web and then receive management response via the outbound flow. Outbound management responses may be validated and encrypted by the modules 218 and 222, which then forward the management responses to the requester via the Web. The management responses are sent from the management module 226 to the validation module 218. In alternative implementations, outbound management responses may also be archived by the archival module 220, which then forwards the management responses to the requestor via the Web.

The archival module 220 indexes each validated outbound message and records it in a searchable archive in the data store 224. In this manner, invalid outbound messages do not occupy valuable storage space in the archive. By indexing the message, the archive is keyword-searchable across all dates, allowing a user or administrator to search the archive through the management interface and retrieve found messages.

In addition to outbound messages being sent to the archival module 220, they may also be copied and forwarded to a mobility module 216, which forwards the validated message on to a mobile communications device or other remote system.

In one implementation, the data integrity policy defines an encryption policy, which may include or reference public keys of intended message recipients. Therefore, having identified an encryption policy, the data integrity system 200 can encrypt a message with an intended recipient's public key based on the destination address. The encryption module 222 can automatically look up the public key associated with the destination address and encrypt the message before the message is forwarded to the destination address via communications network 206.

In summary, the outbound flow allows a data integrity policy to be selected and applied by a policy module 217 for a given outbound message based on message parameters and, in at least one implementation, a security identifier. A validation module 218 attempts to validate the outbound message. Invalidated messages are passed to quarantine, and validated messages are passed along in the outbound flow. An archival module 220 indexes the outbound message and passed a copy of the message into an archive of the data store 224. Depending on the data integrity policy, the validation module 218 (or the archival module 220) may forward a copy of the message to the mobility module 216. After validation and archival, the outbound message is encrypted by the encryption module 222 using a public key determined by virtue of the selected data integrity policy. After traversing the outbound flow modules of the data integrity system 200, the outbound message transmitted to the intended destination via the communications network 206.

It should be understood that individual modules may be combined, particularly modules performing similar or complementary functions for inbound and outbound flows.

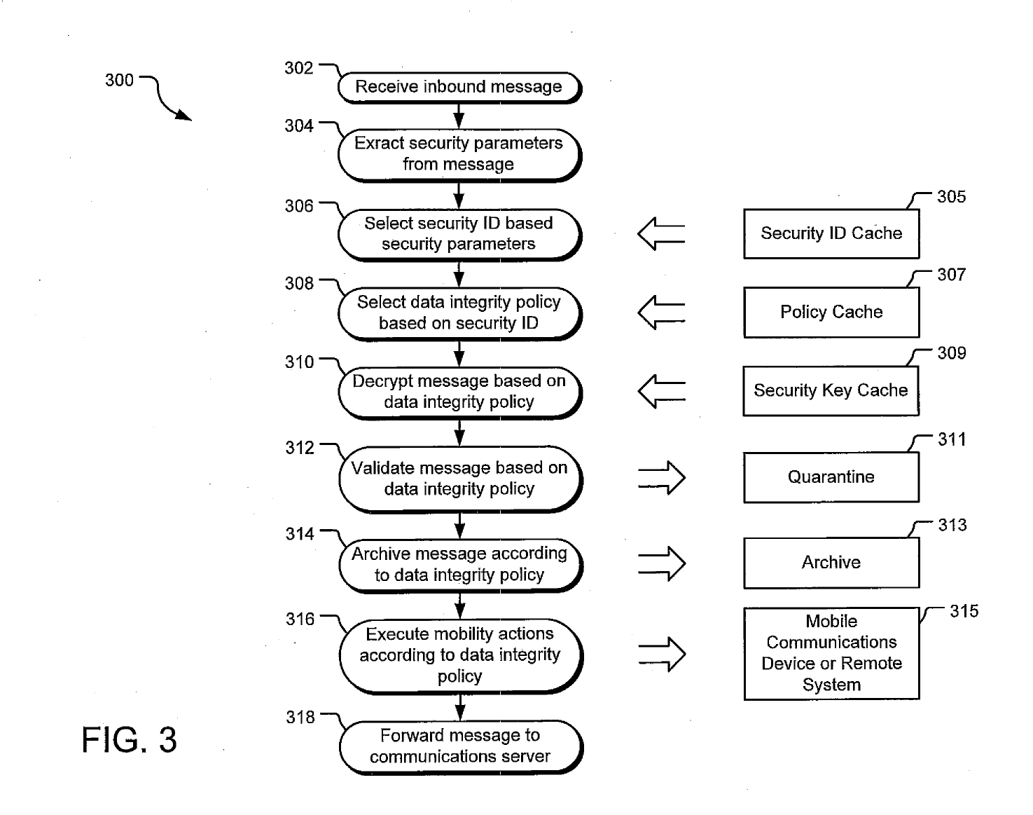

FIG. 3 illustrates example operations 300 for processing inbound communications. A receiving operation 302 receives an inbound message, such an inbound email message, a transferred file, etc. For example, the receiving operation 302 can receive an inbound email message routed from a remote email server through the Internet. The inbound message may be encrypted (or not) and/or infected (or not). Accordingly, a data integrity system processes the inbound message to protect the receiving system and provide additional functionality.

A parameter operation 304 examines the received message to extract one or more policy parameters. Example policy parameters may include the source address, the destination address, the type of message, whether the message is encrypted, the time the message was sent, the time the message was received, etc. Based on the extracted policy parameters, a selection operation 306 selects a security identifier (ID) from a security ID cache 305. Generally, a security ID associates the received message a data integrity policy from the policy cache 307. Another selection operation 308 selects (from a policy cache 307) a specific data integrity policy associated with the previously security ID. For example, the selection operation 306 may select a specific data integrity policy configured for all inbound messages directed to a specified recipient. Alternatively, the selection operation 306 may select a different data integrity policy configured for all inbound messages directed to a specified recipient from a specified source.

If the received message is encrypted, a decryption operation 308 can decrypt the message based on a security policy specified in or referenced by the data integrity policy. For example, if the message was encrypted using the public key of the intended recipient, the decryption operation 308 can select from a security key cache 309 a private key associated with the intended recipient (i.e., the destination address). The security policy of the selected data integrity policy can specify the appropriate private key from a plurality of private keys stored in the security key cache 309. Likewise, the security policy of the selected data integrity policy may exclude certain messages from decryption.

A validation operation 312 detects any spam, suspected spam or infected messages based on a validation policy specified in or referenced by the data integrity policy. The validation policy may include virus and spam definitions, scanning preferences, and other guidance for the validation operation 312. For example, the validation policy may set a time for periodic updates of virus and spam definitions. In another example, the validation policy may include white list or black list source addresses for inbound communications. If the validation operation 312 detects a spam message, the message can be sent to a spam section of a quarantine 311. If the validation operation 312 detects a suspected spam message, the message can be sent to a suspected spam section of the quarantine 311. If the validation operation 312 detects a virus infected message, the message can be sent to a virus section of a quarantine 311. Generally, messages sent to quarantine are not initially forwarded through the inbound flow to a communications server. At a later time, a user or administrator can access the quarantine 311 and decide whether a quarantined message can be validated and reintroduced to the inbound flow. Otherwise, the quarantined message can be deleted or purged in the normal course of operation.

An archival operation 314 indexes validated inbound messages and stores the indexed inbound messages in an archive 313. In this manner, a user or administrator can access the archive via a management module to search for a desired message using a search mechanism (e.g., a keyword search, a date/time search, etc.). The archival operation 314 may be configured by an archival policy specified in or referenced by the data integrity policy. For example, the archival policy may specify indexing methods, impose access control for certain files in the archive, cause certain messages to be ignored by the archival operation 314, etc.

A mobility operation 316 receives validated inbound messages and forwards the messages to a mobile device or some other remote system 315, in accordance with a mobility policy specified in or referenced by the data integrity policy. For example, a validated inbound message may be forwarded via email or SMS to a Smartphone specified in the mobility policy. Furthermore, the mobility policy may specify that only messages satisfying specified criteria are forwarded.

A forwarding operation 318 receives messages that have traveled through some or all of the inbound flow and forwards those messages on to a communications server, such as an email server. It should be understood that the various caches can be stored in a common data store within or accessible by the data integrity system or they may be distributed across multiple data stores.

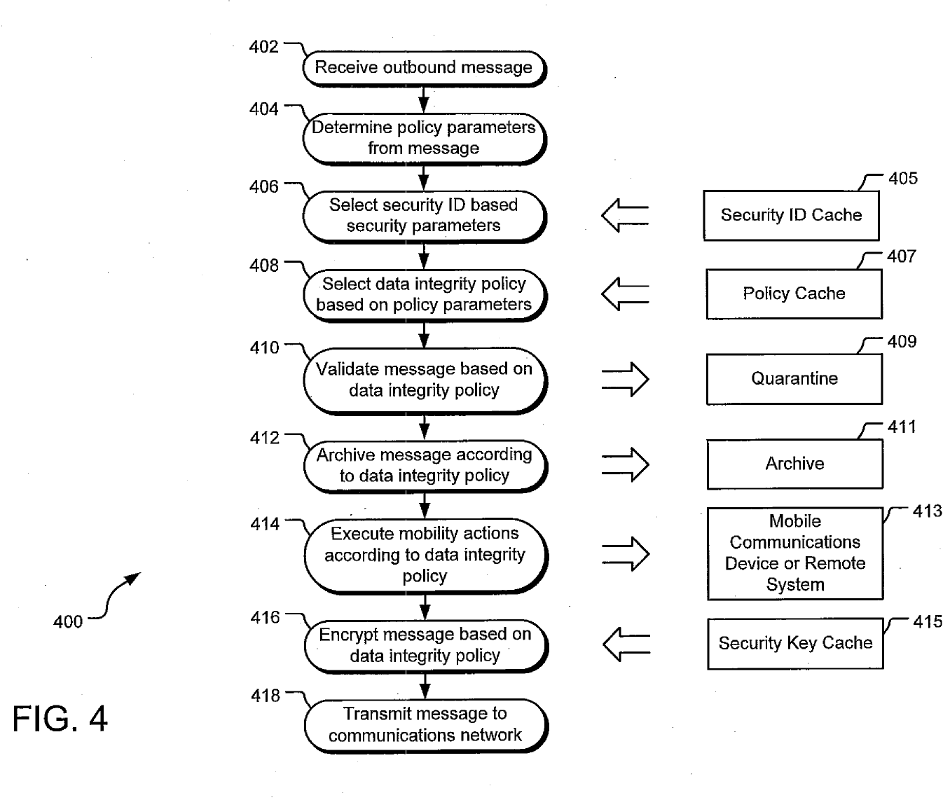

FIG. 4 illustrates example operations 400 for processing outbound communications. A receiving operation 402 receives an outbound message, such an outbound email message, a transferred file, etc. For example, the receiving operation 402 can receive an outbound email message from a communication server. A parameter operation 404 examines the received message to extract one or more policy parameters. Example policy parameters may include the source address, the destination address, the type of message, whether the message is encrypted, the time the message was sent, the time the message was received, etc. Based on the extracted policy parameters, a selection operation 406 selects a security identifier (ID) from a security ID cache 405. Another selection operation 408 selects from a policy cache 407 a specified data integrity policy associated with the previously selected security ID. For example, the selection operation 406 may select a specific data integrity policy configured for all outbound messages directed to a specified recipient. Alternatively, the selection operation 406 may select a different data integrity policy configured for all outbound messages directed to a specified recipient from a specified source.

A validation operation 410 detects any spam, suspected spam or infected messages based on a validation policy specified in or referenced by the data integrity policy. The validation policy may include virus and spam definitions, scanning preferences, and other guidance for the validation operation 410. For example, the validation policy may set a time for periodic updates of virus and spam definitions. In another example, the validation policy may include white list or black list source addresses for outbound communications. If the validation operation 410 detects a spam message, the message can be sent to a spam section of a quarantine 409. If the validation operation 410 detects a suspected spam message, the message can be sent to a suspected spam section of the quarantine 409. If the validation operation 410 detects a virus infected message, the message can be sent to a virus section of a quarantine 409. Generally, messages sent to quarantine are not initially forwarded through the outbound flow to a communications server. At a later time, a user or administrator can access the quarantine 409 and decide whether a quarantined message can be validated and reintroduced to the outbound flow. Otherwise, the quarantined message can be deleted or purged in the normal course of operation.

An archival operation 412 indexes validated outbound messages and stores the indexed outbound messages in an archive 411. In this manner, a user or administrator can access the archive via a management module to search for a desired message using a search mechanism (e.g., a keyword search, a date/time search, etc.). The archival operation 411 may be configured by an archival policy specified in or referenced by the data integrity policy. For example, the archival policy may specify indexing methods, impose access control for certain files in the archive, cause certain messages to be ignored by the archival operation 412, etc.

A mobility operation 414 receives validated outbound messages and forwards the messages to a mobile device or some other remote system 413, in accordance with a mobility policy specified in or referenced by the data integrity policy. For example, a validated outbound message may be forwarded via email or SMS to a Smartphone specified in the mobility policy. Furthermore, the mobility policy may specify that only messages satisfying specified criteria are forwarded.

An encryption operation 416 may encrypt the message based on a security policy specified in or referenced by the data integrity policy. For example, if the message was encrypted using the public key of the intended recipient, the encryption operation 416 can select from a security key cache 415 a private key associated with the intended recipient (i.e., the destination address). The security policy of the selected data integrity policy can specify the appropriate private key from a plurality of private keys stored in the security key cache 415. Likewise, the security policy of the selected data integrity policy may exclude certain messages from decryption.

A forwarding operation 418 receives messages that have traveled through some or all of the outbound flow and transmits those messages on via the communications network to their intended destinations. It should be understood that the various caches can be stored in a common data store within or accessible by the data integrity system or they may be distributed across multiple data stores.

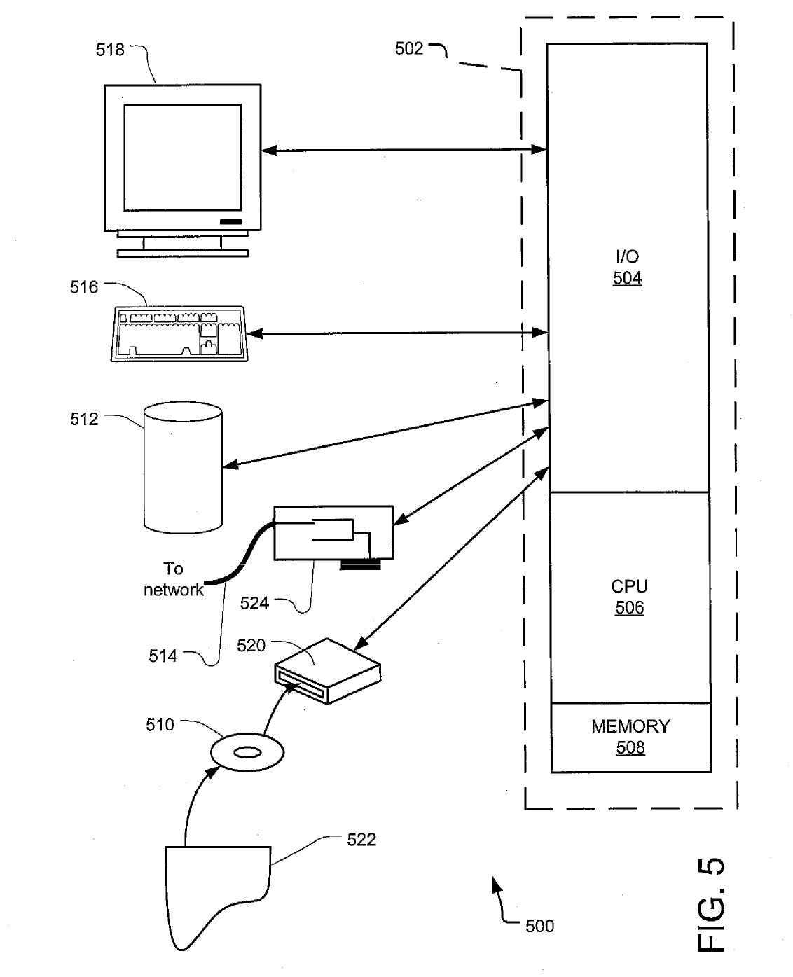

FIG. 5 illustrates an exemplary system useful in implementations of the described technology. A general purpose computer system 500 is capable of executing a computer program product to execute a computer process. Data and program files may be input to the computer system 500, which reads the files and executes the programs therein. Some of the elements of a general purpose computer system 500 are shown in FIG. 5 wherein a processor 502 is shown having an input/output (I/O) section 504, a Central Processing Unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, or any other type of computer. The described technology is optionally implemented in software devices loaded in memory 508, stored on a configured DVD/CD-ROM 510 or storage unit 512, and/or communicated via a wired or wireless network link 514 on a carrier signal, thereby transforming the computer system 500 in FIG. 5 to a special purpose machine for implementing the described operations.

The I/O section 504 is connected to one or more user-interface devices (e.g., a keyboard 516 and a display unit 518), a disk storage unit 512, and a disk drive unit 520. Generally, in contemporary systems, the disk drive unit 520 is a DVD/CD-ROM drive unit capable of reading the DVD/CD-ROM medium 510, which typically contains programs and data 522. Computer program products containing mechanisms to effectuate the systems and methods in accordance with the described technology may reside in the memory section 504, on a disk storage unit 512, or on the DVD/CD-ROM medium 510 of such a system 500. Alternatively, a disk drive unit 520 may be replaced or supplemented by a floppy drive unit, a tape drive unit, or other storage medium drive unit. The network adapter 524 is capable of connecting the computer system to a network via the network link 514, through which the computer system can receive instructions and data embodied in a carrier wave. Examples of such systems include personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are exemplary and other means of and communications devices for establishing a communications link between the computers may be used.

In an exemplary implementation, validation modules, encryption/decryption modules, policy modules, archival modules, mobility modules, and other modules may be incorporated as part of the operating system, application programs, or other program modules. Archives, quarantines, data integrity policies, messages, and other data may be stored as program data.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method comprising:
determining a security identifier based on a received message;
selecting a data integrity policy from a plurality of data integrity policies based on the security identifier;
determining whether the received message is validated in accordance with the selected data integrity policy;
passing the received message to quarantine if the received message is not validated in the operation of determining whether the received message is validated.

2. The method of claim 1 wherein the operation of determining a security identifier comprises:
determining the security identifier based on a destination address of the received message.

3. The method of claim 1 wherein the operation of determining a security identifier comprises:
determining the security identifier based on a source address of the received message.

4. The method of claim 1 wherein the data integrity policy associates the received message with a public key used to encrypt the received message for an intended recipient of the received message.

5. The method of claim 1 wherein the data integrity policy associates the received message with a private key used to decrypt the received message for an intended recipient of the received message.

6. The method of claim 1 further comprising:
decrypting the received message prior to the operation of determining whether the received message is validated in accordance with the selected data integrity policy.

7. The method of claim 1 further comprising:
encrypting the received message after the operation of determining whether the received message is validated in accordance with the selected data integrity policy.

8. The method of claim 1 further comprising:
recording the validated received message in a searchable archive after the operation of determining whether the received message is validated in accordance with the selected data integrity policy.

9. The method of claim 8 wherein the received message is received in an encrypted form and further comprising:
decrypting the received message prior to validating the received message;
indexing the decrypted validated received message for a search index of the searchable archive, wherein the recording operation records the encrypted received message in the searchable archive.

10. The method of claim 9 further comprising:
searching the search index of the searchable archive, based on a search condition, to identify the encrypted validated received message satisfying the search condition.

11. The method of claim 1 further comprising:
forwarding the received message to a remote communications device in accordance with the selected data integrity policy.

12. The method of claim 1 further comprising:
allowing a user to access the received message in the searchable archive if an access list of the user includes an entry associated with the security identifier of the received message.

13. A tangible computer-readable medium having computer-executable instructions for performing a computer process, the computer process comprising:
selecting a data integrity policy from a plurality of data integrity policies based on a security identifier associated with a received message;
determining whether the received message is validated in accordance with the selected data integrity policy;
passing the received message to quarantine if the received message is not validated in the determining operation.

14. The tangible computer-readable medium of claim 13 wherein the determining operation comprises:
determining the security identifier based on a destination address of the received message.

15. The tangible computer-readable medium of claim 13 wherein the determining operation comprises:
determining the security identifier based on a source address of the received message.

16. The tangible computer-readable medium of claim 13 wherein the data integrity policy associates the received message with a public key used to encrypt the received message for an intended recipient of the received message.

17. The tangible computer-readable medium of claim 13 wherein the data integrity policy associates the received message with a private key used to decrypt the received message for an intended recipient of the received message.

18. The tangible computer-readable medium of claim 13 wherein the computer process further comprises:
decrypting the received message prior to the operation of determining whether the received message is validated in accordance with the selected data integrity policy.

19. The tangible computer-readable medium of claim 13 wherein the computer process further comprises:
encrypting the received message after the operation of determining whether the received message is validated in accordance with the selected data integrity policy.

20. The tangible computer-readable medium of claim 13 wherein the computer process further comprises:
recording the validated received message in a searchable archive after the operation of determining whether the received message is validated in accordance with the selected data integrity policy.

21. The tangible computer-readable medium of claim 13 wherein the received message is received in an encrypted form and the computer process further comprises:
decrypting the received message prior to validating the received message;
indexing the decrypted validated received message for a search index of the searchable archive, wherein the recording operation records the encrypted received message in the searchable archive.

22. The tangible computer-readable medium of claim 21, wherein the computer process further comprises:
searching the search index of the searchable archive, based on a search condition, to identify the encrypted validated received message satisfying the search condition.

23. The tangible computer-readable medium of claim 13 wherein the computer process further comprises:
forwarding the received message to a remote communications device in accordance with the selected data integrity policy.

24. The tangible computer-readable medium of claim 13 wherein the computer process further comprises:
allowing a user to access the received message in the searchable archive if an access list of the user includes an entry associated with the security identifier of the received message.

25. A tangible computer-readable medium having computer-executable instructions for performing a computer process, the computer process comprising:
identifying a data integrity policy based on a security identifier associated with the received message;
validating the received message based on the identified data integrity policy;
recording the validated received message in a searchable archive;
transmitting the validated and recorded received message via a communications network.

26. The tangible computer-readable medium of claim 25 wherein the computer process further comprises:
encrypting the validated and recorded received message based on the identified data integrity policy, subsequent to transmitting the validated and recorded received message.

27. The tangible computer-readable medium of claim 25 wherein the computer process further comprises:
decrypting the received message based on the identified data integrity policy, prior to validating and recording the received message.

28. The tangible computer-readable medium of claim 25 wherein the recording operation comprises:
recording the validated received message in a searchable archive based on a security identifier associated with the received message.

29. The tangible computer-readable medium of claim 25 wherein the computer process further comprises:
searching for the validated and recorded received message in the searchable archive.

30. The tangible computer-readable medium of claim 25 wherein the received message is received in an encrypted form and the computer process further comprises:
decrypting the received message prior to validating the received message;
indexing the decrypted validated received message for a search index of the searchable archive, wherein the recording operation records the encrypted received message in the searchable archive.

31. The tangible computer-readable medium of claim 30, wherein the computer process further comprises:
searching the search index of the searchable archive, based on a search condition, to identify the encrypted validated received message satisfying the search condition.

32. A method comprising:
identifying a data integrity policy associated with a received message;
validating the received message based on the identified data integrity policy;
recording the validated received message in a searchable archive;
transmitting the validated and recorded received message via a communications network.

33. The method of claim 32 further comprising:
encrypting the validated and recorded received message based on the identified data integrity policy, subsequent to transmitting the validated and recorded received message.

34. The method of claim 32 further comprising:
decrypting the received message based on the identified data integrity policy, prior to validating and recording the received message.

35. The method of claim 32 wherein the recording operation comprises:
recording the validated received message in a searchable archive based on a security identifier associated with the received message.

36. The method of claim 32 further comprising:
searching for the validated and recorded received message in the searchable archive.

37. The method of claim 32 wherein the received message is received in an encrypted form and further comprising:
decrypting the received message prior to validating the received message;
indexing the decrypted validated received message for a search index of the searchable archive, wherein the recording operation records the encrypted received message in the searchable archive.

38. The method of claim 37 further comprising:
searching the search index of the searchable archive, based on a search condition, to identify the encrypted validated received message satisfying the search condition.
